(19) United States
(12) Patent Application Publication
(10) Pub. No.: US 2026/0354632 A1
(43) Pub. Date: Nov. 12, 2026

(54) Trip and Nonis Magic Potty Chair

(71) Applicant: Crystal Shipman, Surprise, AZ (US)

(72) Inventor: Crystal Shipman, Surprise, AZ (US)

(21) Appl. No.: 19/204,553

(22) Filed: May 11, 2025

(51) Int. Cl. A47K 11/04; G09B 19/00

(52) U.S. Cl. CPC A47K 11/04; G09B 19/00

(57) ABSTRACT

Potty chair components, kits and methods for toilet training are provided that include (1) a book with a story that encourages toilet training success, (2) a container of “magic powder” that is preferably comprised of food grade sodium bicarbonate and food grade powdered dye (e.g., of different colors), (3) a container of “magic fizzy powder” preferably comprised of food grade citric acid, (5) additional containers of substances in certain embodiments, and (5) written instructions. A potty chair is also provided that can use the book, “magic powder”, “magic fizzy powder”, possible other containers of substances, and written instructions in the toilet training of a child.

### FIELD OF THE INVENTION

The invention relates to potty chair components, kits and methods for toilet training a child.

### BACKGROUND OF THE INVENTION

Toilet training a child can be difficult and cause anxiety and discord in a family and particularly with a child who is comfortable with diapers and does not want to change habits and/or a child that is fearful or anxious with the toilet (e.g., potty, potty chair) or using the toilet.

The use of a system that indicates a child has voided or otherwise encourages a child to use a toilet have been tried in the past but suffer from a number of deficiencies. Some indicators fail in transit or storage due to conditions such as the weather (e.g., humidity), which can make them display a positive result before they are even used. In other cases, indicators fail because the indicator does not change as intended and a wrong result occurs (e.g., wrong or no color). Still another problem was from the components (e.g., compressed sponges) not being easily discarded by flushing down a toilet. Still another problem is if certain chemicals were used that were not generally established or recognized as safe and might have potential caustic or even toxic results to humans and/or plumbing (e.g., sewer or septic). Still another problem is if the system does not encourage and reward the child for expressing desired behavior and aid the toilet training process. In addition, prior systems may have used wands or other components that posed some risks to safety in the hands of children.

A better solution is thus needed where the components are stable in transit and storage, the components are more reliable, and the components are safe to handle and easily disposable. It would also be advantageous to provide a solution that encourages and rewards the child for desired behavior and which aids the toilet training process.

### SUMMARY OF THE INVENTION

Certain embodiments of this invention provide better solutions for toilet training a child, which are in the form of kits and methods for toilet training.

Embodiments of this invention provide kits for successfully toilet training a child that are used by the child and an adult. The toilet used herein has a dry bowl, such as a dry potty chair basin or similar or equivalent device. The kits comprise (a) a book with a story that encourages toilet training success; (b) a first powder container comprising a food grade powdered dye and food grade sodium bicarbonate; (c) a second powder container comprising a food grade fizzing agent; and (d) a written instruction that instructs an adult how to use the book to tell the story to the child, use the first powder to add to the toilet dry bowl to provide color to the contents of the toilet bowl when it is successfully used by the child, and use the second powder to cause fizzing in the toilet. In certain embodiments, the food grade fizzing agent comprises food grade citric acid. In certain of these embodiments, the first powder container and the second powder container each comprise a child resistant resealable plastic bag that stands up on a countertop. In certain of these embodiments, one or more additional containers are used, each with the same or different contents (e.g., contents that provide multiple color choices). In certain of these embodiments, additional components are added, or only some of the components identified above are used.

Certain embodiments of this invention also provide methods for successfully toilet training a child, wherein the toilet has a dry toilet bowl before use, which methods are used by the child and an adult. These methods comprise (a) reading a book with a story that encourages toilet training success to the child, the reading done by the adult; (b) adding a first powder comprising food grade powdered dye and food grade sodium bicarbonate from a first powder container to the toilet dry bowl that will change color when the toilet is used by the child, the adding done by the adult; (c) having the child use the toilet, causing the contents to change color; (c) adding a second powder comprising food grade fizzing agent from a second powder container to the toilet that causes fizzing in the toilet, the adding done by the adult; and (e) praising the child for using the toilet, the praising done by the adult. In certain of these embodiments, the food grade fizzing agent comprises food grade citric acid. In certain of these embodiments, the first powder container and the second powder container each comprise a child resistant resealable plastic bag that stands up on a countertop. In preferred embodiments of these, the book, the first powder container, and the second powder container are provided in a kit. In certain of these embodiments, one or more additional containers are used, each with the same or different contents (e.g., contents that provide multiple color choices). In certain of these embodiments, additional components are added, or only some of the components identified above are used.

Certain preferred embodiments of this invention comprise a kit with components that include but are not limited to: (1) a book with a story that encourages toilet training success, (2) a first container (e.g., resealable standup bag) of “magic powder” that is preferably comprised of food grade sodium bicarbonate and food grade powdered dye (e.g., of different colors), (3) a second container (e.g., resealable standup bag) of “magic fizzy powder” preferably comprised of food grade citric acid, and (4) written instructions. The kits can then be used in methods, that, for example, include following the written instructions. In certain of these embodiments, one or more additional containers are used, each with the same or different contents (e.g., contents that provide multiple color choices). In certain of these embodiments, additional components are added, or only some of the components identified above are used.

The second powder used in certain embodiments of this invention can comprise fizzing (i.e., effervescence) agents that include food safe acids, such as citric acid, or tartaric acid, which can be provided in powder form and start reacting as soon as they dissolve in water, and especially in the presence of sodium bicarbonate.

In the most preferred embodiments, the combination of food grade sodium bicarbonate and food grade citric acid provided the most advantageous results that had been observed.

In certain embodiments of this invention, the “magic powder” and the “magic fizzy powder” are each stored in or on a potty chair (e.g., in containers attached to, on, or otherwise within or part of a potty chair). The potty chair may have a lid and a potty chair bowl, which is preferably removeable for cleaning. When it is time to use each of the powders as described herein, the powders are manually, mechanically, or automatically released from the potty chair and into its bowl at the appropriate times. In certain of these embodiments the potty chair further comprises a lid to the potty chair that has attached to it multiple containers, each container shaped like a tube, that each control the retention and release of the “magic powder” or the “magic fuzzy powder” into the potty chair bowl. In preferred embodiments, the potty chair bowl has sides that direct any added powder to the center area of the potty chair bowl.

In certain embodiments of this invention there are multiple (e.g., two or more) containers (e.g., containers that dispense or dispensers) that are provided. The use of multiple containers can provide advantages, such as the release into the potty chair bowl of substances (e.g., powders) that can have different attributes (e.g., different color options).

Advantages of the embodiments of this invention are described and apparent throughout this specification. For example, certain embodiments use a book that works with the other components to encourage success in toilet training. These can be fun and amusing for the child and for the adult as well. They can reduce stress and anxiety in toilet training.

Additional advantages of certain embodiments include safe, reliable and stable “magic powder” that when used as directed is used in order to provide the child with a reward for success. An additional “fizzy powder” can also be used. Certain embodiments provide instructions that when used facilitate the components being used in each toilet use together to increase the chances for toilet training success. Certain embodiments provide safe components that reduce risks to children when used as directed and which are relatively safe (e.g., use food grade components), affordable, and easy to dispose of when used as directed and that do not harm plumbing (e.g., sewer or septic).

The use of food grade components is preferred for the advantages they provide in safety, knowledge of their properties, availability, cost, and ease of disposal in household plumbing.

Still additional advantages can include avoiding the use of diapers, which can save money for a family and reduce waste in landfills and otherwise help the environment. Further advantages will be apparent to a person of skill in the art applying the embodiments of the invention.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

FIG. 1 is a schematic showing examples of components that are used in kits and methods of embodiments of this invention.

FIG. 2 is a schematic showing embodiments of a potty chair and a potty chair basin or bowl of this invention.

### DETAILED DESCRIPTION OF THE INVENTION

The invention provides better solutions for toilet training a child, which are needed, and which are in the form of kits and methods for toilet training.

Some embodiments of this invention comprise a kit with components that include but are not limited to: (1) a book with a story that encourages toilet training success, (2) a container of “magic powder” that is preferably comprised of food grade sodium bicarbonate and food grade powdered dye, and which can cause a color change in a toilet to reward a child, (3) a container of “magic fizzy powder” preferably comprised of citric acid that can be used to further reward a child with “fizzing” in the toilet, and (4) written instructions. In certain of these embodiments, one or more additional containers are used, each with the same or different contents (e.g., contents that provide multiple color choices). In certain of these embodiments, additional components are added, or only some of the components identified above are used.

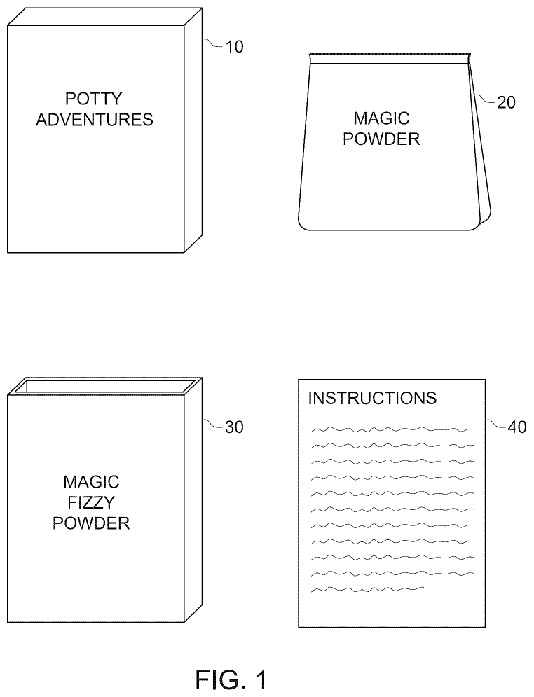

FIG. 1 shows a schematic of an example of components of kits and that are used in methods of embodiments of this invention. The contents of an exemplary kit 1 are shown and they comprise a book 10, titled “Trip and Noni'Potty Adventures”, a Magic Powder child resistant and resealable standup bag container 20, preferably comprised of food grade sodium bicarbonate and food coloring dye, a Magic Fizzy Powder child resistant and resealable standup bag container 30, preferably comprised of food grade citric acid, and an instructions sheet 40.

The goal of the kits and the associated methods are to aid in the transition of children out of diapers and reducing any fear, stress, or anxiety (if it is present) of using the toilet. This will help reduce landfill volume and aid the planet, as well as reduce expenses for families by eliminating diaper and wet-wipe costs. This will also be safer from household plumbing than other prior art components and methods. The kits and methods of this invention are fun and rewarding for the child and provide positive reinforcement for successful toilet use.

The book described herein contains a story that is comprised of characters that use or otherwise relate to the components of the invention in toilet training and which encourage toilet training success. One such embodiment uses characters known as Trip and Noni, who are on a “Potty Adventure” for intended ages of 18 months and older (other age ranges can be used). In this particular embodiment, Trip invented a magic powder for his little sister Noni and a magic spell that the child can participate in by waving their arms. The books may come as one story, or as a series of stories in different books.

The containers (e.g., double sealed, child resistant or childproof) of “magic powder” can be made of a waterproof material (e.g., plastic) and be opened by tearing open a standup bag, as an example. Some embodiments include a measuring device (e.g., plastic tablespoon), while others are used by simply pouring some of the contents into the toilet. These containers preferably comprise food grade sodium bicarbonate and a food grade powdered dye contained within. Quantities that are used for each toilet use may include 1 Tablespoon, as an example, but other quantities can be used. The ratio of sodium bicarbonate to powdered dye may be 5 to 1, but different ratios of the two can be used, as will be known to a person of skill in the art reading this specification. It is important that these contents be relatively safe for humans, the environment, and plumbing (e.g., sewer and septic) and thus it is preferred that food grade contents be used. These containers are used by adults by putting their contents in the toilet dry bowl and making “magic water” for the child using the toilet, whereby the contents of the toilet turns to a color because of the dye. One of skill in the art will know that different containers besides child resistant and resealable standup bags (e.g., plastic bottles, packets, envelopes, and any other containers made of materials suitable for powders) and different quantities can be used. In certain most preferred embodiments, the “magic powder” is added to a dry potty chair basin (referred to generally herein as a “bowl”).

In addition to sodium bicarbonate, other powders can be used with or instead of the sodium bicarbonate. Certain of these substitutions and/or additions can be other powders that produce carbon dioxide when the magic fuzzy powder is added. For example, such powders may be capable of producing carbon dioxide when citric acid is added.

The containers (e.g., dispensers, double sealed, child resistant or child proof) of “magic fuzzy powder” can be made of a waterproof material (e.g., plastic) and be opened by tearing open a standup bag, as an example. These containers preferably comprise citric acid. Some embodiments include a measuring device (e.g., plastic tablespoon), while others are used by simply pouring some of the contents into the toilet. This powder is also preferably food grade and relatively safe for the child and the plumbing (e.g., sewer or septic). Quantities may include 1 Tablespoon of citric acid per toilet use, as an example, but other quantities can be used, as will be known to a person of skill in the art reading this specification. It is important that the contents be relatively safe for humans, the environment, and plumbing (e.g., sewer and septic). These containers are used by the adult, after the “magic water” is made, by placing the contents in the toilet and creating “magic fizzing” for an added reward for the child. This will make the child feel more comfortable and excited with the toilet and the training process and engage the child to use the toilet again and again. One of skill in the art will know that different containers besides child resistant and resealable standup bags (e.g., plastic bottles, packets, envelopes, and any other containers made of materials suitable for powders) and different quantities can be used.

The instructions can comprise an instruction sheet containing words and pictures. It can be in a comic book or other form. It can also include a thank you letter explaining the benefits of the invention, such as, for example, the benefits to the child and the environment.

A preferred embodiment of the instructions is the following:

“Upon the kit arriving, adults will read the book to the child and have the child fall in love or be otherwise engaged with Trip and Noni's story prompting the desire to make Magic Water. The adult will sprinkle Magic Powder in the potty chair basin. The child and the adult will shout Trip's magic spell before the child uses the potty. When the child goes potty the water will change to a vibrant color thus exciting the child to repeat the process. After the Magic Water is achieved, the adult will sprinkle the Magic Fizzy powder on the Magic Water and a vibrant fizzy action will occur further exciting the child (the fizzy action will not overflow the potty basin.”

The subject matter of this disclosure is now described with reference to the following examples. These examples are provided for the purpose of illustration only, and the subject matter is not limited to these examples, but rather encompasses all variations which are evident as a result of the teaching provided herein.

### EXAMPLE 1

A preferred embodiment of this invention is a kit that comprises (a) a book with a story that encourages toilet training success, (b) a first plastic child resistant and resealable standup bag (as a type of container) of “magic powder” that is comprised of food grade sodium bicarbonate and food grade powdered dye, and which is used to reward a child with a color change, (c) a second plastic child resistant and resealable standup bag of “magic fizzy powder” comprised of food grade citric acid, and (d) written instructions. The first and second bags may be of the same size and material or they can be different. The kit may come in the form of a box, bag or other container. The standup bags may hold 3 ounces of contents, or a different amount. While some suggested amounts of ingredients are used in this example, other amounts can be used and still practice this invention. The bags may also contain a measuring spoon or similar device (e.g., plastic 1 Tablespoon).

In certain of the most preferred embodiments, each kit may contain 3-4 containers of “magic powder”, each with three ounces of contents, in resealable food safe plastic bags. Larger kits can be provided for uses where there may be additional children (e.g., large families, schools, day care centers).

### EXAMPLE 2

A preferred embodiment of this invention is a method of toilet training a child, the toilet having a dry bowl before use, that comprises: (a) reading a book with a story to the child, the story comprising characters and the changing of the color of water, (b) adding food grade sodium bicarbonate and food grade food dye powder to the toilet dry bowl, (c) having the child use the toilet, (d) adding food grade citric acid to the toilet, and (e) rewarding the child with praise. In the practice of this method, step (b) will change the color of the contents in the toilet and serve as a reward for the child and encourage the child to use the toilet (e.g., instead of diapers). Step (c) will add fizz to the water and further add a reward for the child and otherwise encourage the child to use the toilet (e.g., instead of diapers). The book in this method will relate to at least steps (b) and (d) and the color change and fizz to provide context and excitement to the child and increase the chance for success at toilet training.

### EXAMPLE 3

In these embodiments, instead of food grade sodium bicarbonate, other ingredients are used, such as food grade powdered sugar, salt, baking powder, cream of tartar, powdered gelatin, talc, or another white food powder can be used. It is preferred that these other ingredients be relatively safe, food grade if possible, and produce a change or effect in the toilet bowl that can be seen by a child

### EXAMPLE 4

In these embodiments, a potty chair for a child is provided. The potty chair stores the “magic powder” and the “magic fuzzy powder” within it, on it, or attached to it (e.g., in a container provided within, on, or attached to the potty chair). The powders can be released at the appropriate time into the bowl of the potty chair as described in Example 3 manually by an adult (e.g., parent or care giver), mechanically with a release mechanism, or automatically using sensors well known to a person of skill in the art, or by other methods.

In certain of these embodiments, there are two or more containers (e.g., dispensers, tubes) in, on, or attached to the toilet that store the “magic powder” and/or the “magic fuzzy powder”. In certain preferred embodiments of these, the tube containers work in a manner similar to a coin dispenser/sorter that is comprised of a number of tubes that contain the contents and have a mechanism to retain and then release the contents in a controlled manner. The contents can be dispensed manually, mechanically (e.g., by a lever or push button), or automatically (e.g., electrically with servo-like mechanisms controlled by a computer app) from the containers, depending on the embodiment, and directly into the potty chair basin. In certain preferred embodiments, the potty chair basin is removeable and it has an angle or curved design like an inverted cone or a similar shape that help direct the contents of the tube containers when they are release into the center of the potty chair basin. The potty chair basin has a splash guard in certain embodiments.

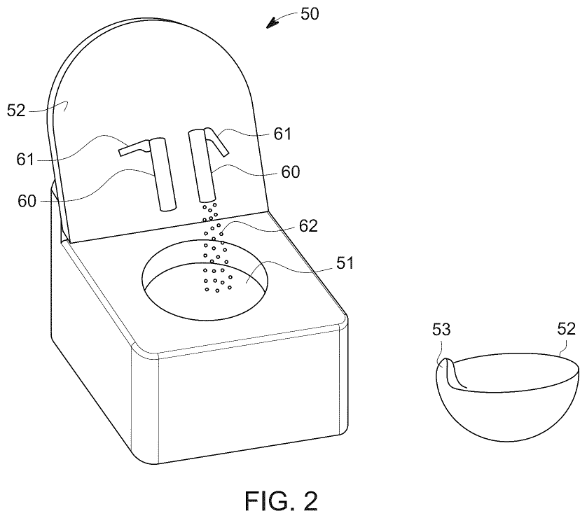

FIG. 2 is a schematic of a potty chair embodiment 50 of this invention. The potty chair 50 in this embodiment has a lid 52 with two tube containers 60 attached to it. It also has a potty chair basin 51 (also referred to herein as a potty chair bowl). In other embodiments, not shown, there are more than two tube containers or containers of different shapes. In FIG. 2, one tube container has “magic powder” contained within it and the other has “magic fuzzy powder” contained within it. A lever 61 controls the retention and the release of the powders in each container 60.

In FIG. 2, the potty chair 50 is shown with one lever 61 activated and a powder 62 being released into the potty chair basin 51. An embodiment of a potty chair basin 52 is also shown in FIG. 2 and it is removeable from the potty chair and it has sides shaped at an angle so that the release of any powder is directed to the center portion of the potty chair basin 52. This can improve the chances of having a successful use of the powders with the contents of the potty chair basin (or bowl). This embodiment also has a splash guard 53 illustrated in FIG. 2.

In the most preferred embodiment of this example, a potty chair, a book, and written instructions for toilet training a child are provided. The potty chair has a dry bowl before use. The potty chair also has stored within it or on it (e.g., in a container attached to the potty chair) a first powder comprising a food grade powdered dye and food grade sodium bicarbonate. The potty chair also has stored within it or on it a second powder comprising a food grade fizzing agent. The book contains a story that encourages toilet training success. The written instructions instruct the adult how to use the book to tell the story to the child, use the first powder to add to the potty chair bowl to provide color to the contents of the toilet bowl when it is successfully used by the child, and use the second powder to cause fizzing in the potty chair. One example of an appropriate second powder is food grade citric acid.

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

What is claimed is:

1. A kit for toilet training a child, the toilet having a dry bowl before use, the kit used by the child and an adult, the kit comprising:
(a) a book with a story that encourages toilet training success;
(b) a first powder container comprising a food grade powdered dye and food grade sodium bicarbonate;
(c) a second powder container comprising a food grade fizzing agent; and
(d) a written instruction that instructs an adult how to (i) use the book to tell the story to the child, (ii) use the first powder to add to the toilet dry bowl to provide color to the contents of the toilet bowl when it is successfully used by the child, and (iii) use the second powder to cause fizzing in the toilet.

2. The kit of claim 1 wherein the food grade fizzing agent comprises food grade citric acid.

3. The kit of claim 1 wherein the first powder container and the second powder container each further comprises a child resistant resealable plastic bag that stands up on a countertop.

4. A method for toilet training a child, the toilet having a dry bowl before use, which method is used by the child and an adult, the method comprising:
(a) reading a book with a story that encourages toilet training success to the child, the reading done by the adult;
(b) adding a first powder comprising food grade powdered dye and food grade sodium bicarbonate from a first powder container to the toilet dry bowl that will change color when the toilet is used by the child, the adding done by the adult;
(c) having the child use the toilet, causing the contents of the toilet to change color;
(c) adding a second powder comprising food grade fizzing agent from a second powder container to the toilet that causes fizzing in the toilet, the adding done by the adult; and
(e) praising the child for using the toilet, the praising done by the adult.

5. The method of claim 4 wherein the food grade fizzing agent comprises food grade citric acid.

6. The method of claim 4 wherein the first powder container and the second powder container each further comprises a child resistant resealable plastic bag that stands up on a countertop.

7. The method of claim 4 wherein the book, the first powder container, and the second powder container are provided in a kit.

8. A potty chair, book, and written instructions for toilet training a child, the potty chair used by the child in the presence of an adult, the potty chair, book, and written instructions comprising:
(a) the potty chair having a bowl,
(b) a first powder container comprising a food grade powdered dye and food grade sodium bicarbonate stored in or on the potty chair;
(c) a second powder container comprising a food grade fizzing agent stored in or on the potty chair;
(d) the book containing a story that encourages toilet training success; and
(e) the written instructions instruct the adult how to (i) use the book to tell the story to the child, (ii) use the first powder by adding it to the potty chair bowl to provide color to the contents of the potty chair bowl when it is successfully used by the child, and (iii) use the second powder by adding it to the potty chair bowl to cause fizzing in the potty chair bowl.

9. The potty chair, book, and written instruction of claim 8 wherein the second powder comprises food grade citric acid.

10. The potty chair of claim 8 further comprising a lid to the potty chair that has attached to it the first powder container and the second powder container.

11. The potty chair of claim 10 wherein the potty chair bowl has sides that direct any powder added to the potty chair bowl to the center area of the potty chair bowl.

12. The potty chair of claim 8 further comprising a lid to the potty chair that has attached to it the first powder container and the second powder container, each such container shaped like a tube, and each such container controlling the retention and release of the first powder or the second powder into the potty chair bowl.

13. The potty chair of claim 8 further comprising one or more additional powder containers, each such container shaped like a tube, and each such container controlling the retention and release of a powder into the potty chair bowl.
